(19) United States
(12) Patent Application Publication
(10) Pub. No.: US 2007/0206755 A1
(43) Pub. Date: Sep. 6, 2007

(54) Method for automatically initiating a call

(76) Inventor: Mohammad Vizaei, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/572,899

(22) PCT Filed: Sep. 10, 2004
(86) PCT No.: PCT/EP04/10103

§ 371 Date: Mar. 13, 2007

(30) Foreign Application Priority Data
Sep. 25, 2003 (EP) 03021720.2

(51) Int. Cl. H04M 3/42

(52) U.S. Cl. 379/201.02

(57) ABSTRACT

A method for automatically initiating a call, according to which the existing connections from a first user of a telecommunication network to other users are detected and are evaluated regarding the statistical regularities thereof while calls are initiated to the other users based on the identified statistical regularities is provided. Particularly service-based companies to inform their clients in a targeted manner is allowed.

### CROSS REFERENCE TO RELATED APPLICATIONS

This application is the US National Stage of International Application No. PCT/EP2004/010103, filed Sep. 10, 2004 and claims the benefit thereof. The International Application claims the benefits of European application No. 03021720.2 EP filed Sep. 25, 2003, both of the applications are incorporated by reference herein in their entirety.

### FIELD OF INVENTION

The invention relates to a method for automatically initiating a call.

### BACKGROUND OF INVENTION

In recent decades telecommunication networks have become an essential element of modern economic life which play a decisive role in helping to shape everyday working life.

To this end, the telecommunication networks have been matched by means of a large number of performance features, in other words functionalities of the terminal devices, to the needs of the users in order to thus facilitate the handling and to enhance the performance.

Examples of such functionalities include:
Call transfer
Call waiting
Three-way conversation
Calling number identification
Automatic callback

For ISDN subscriber connections, the available performance features have been defined in the DSS1 European ISDN Standard.

Completely new capabilities result from the integration of conventional traditional connection oriented TDM networks into packet-switched computer networks.

One example of this is the SURPASS architecture from Siemens, an IP technology offering convergence of voice and data networks. Based on an open architecture, SURPASS brings the high quality and voice service diversity of real-time voice networks into the data networks and conversely enables the use of IP applications in the voice network. This largely guarantees the continuing use of today's network infrastructure. With SURPASS, Siemens brings together the two major worldwide networks, the telephone network (circuit-switched voice network) and the Internet (packet-switched data network) and combines the advantages of packet-oriented, multimedia capable networks with the complete voice intelligence of traditional real-time networks. SURPASS offers an open, highly modular architecture with complete administrations control for each component, based on the SmartCommander operations platform.

The new network structures reduce the number of network elements, lower the operating costs and enable new performance features.

### SUMMARY OF INVENTION

An object underlying the invention is to extend the utilization capabilities for a telecommunication network on the basis of convergent network architectures by means of new performance features.

This object is achieved according to the invention by a method of the type mentioned at the beginning, in which the connections existing from a first user of a telecommunication network to further users are detected and evaluated with respect to their statistical regularities, and in which calls are initiated to the other users on the basis of the identified statistical regularities.

The invention allows particularly service-based companies to provide their clients with information in a targeted manner. Such situations can include, for example, doctors who are notifying their patients of an appointment time or automobile workshops sending reminders about a service which is due.

Advantageous embodiments of the invention are set down in the dependent claims.

It is particularly advantageous in this situation if the calls directed to the first user of a telecommunication network are detected and evaluated. The telephone calls directed to a service provider constitute a basis which is particularly suitable in many cases for the detection and analysis of customer contacts. Such situations can include, for example, regularly recurring ordering processes, such as the “Friday evening call” in the case of a pizza delivery service. It is therefore expedient to evaluate the time of the calls, which in this case therefore yields as a regularity: “The customer orders a pizza every Friday evening between 19.00 and 20.00”. According to the invention, the customer is then actively called on Fridays by the pizza delivery service.

This automatic call expediently contains an automatically generated announcement—a tape announcement—which informs the called customer about a current offer and prompts him to press a particular key or key combination if interested in the offer. When the customer presses this key, a connection is established between the customer and the pizza service.

The detection and evaluation of the calls can be performed in a modern telecommunication network by means of an Open Service Platform in a switching center, such as the Surpass hiQ 4000 from Siemens AG for example, by way of which the calls to the customers are also initiated.

Alternatively, it is also possible to store detection and evaluation of the calls directed to the first user of a telecommunication network and the initiation of the calls to the further users externally in a computer connected to the telecommunication network.

### BRIEF DESCRIPTION OF THE DRAWINGS

The invention is described in more detail with reference to three figures which each represent different phases in the execution of the method according to the invention by way of example.

FIG. 1—an exemplary schematic of an embodiment of the invention;

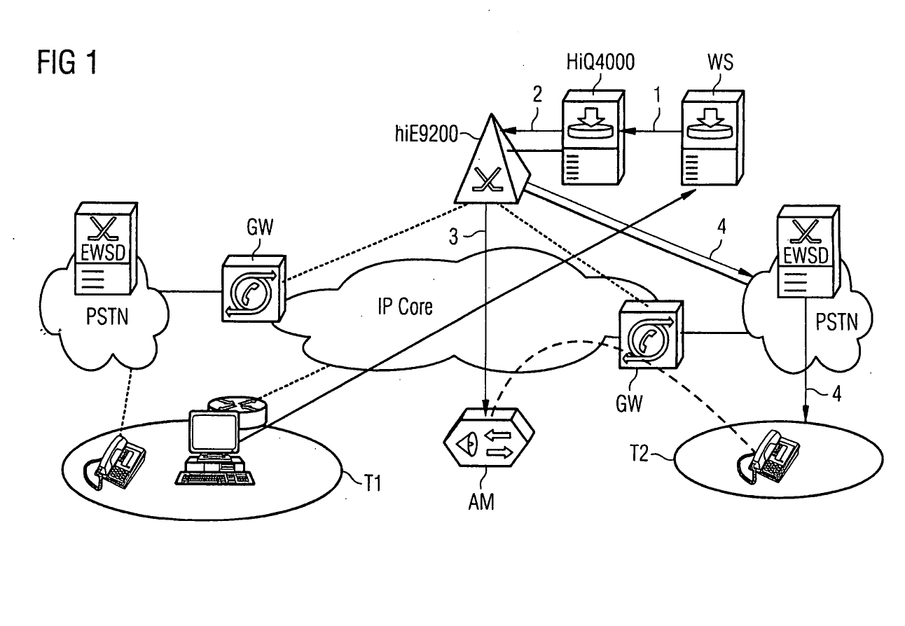

FIG. 2—an exemplary schematic of another embodiment of the invention; and

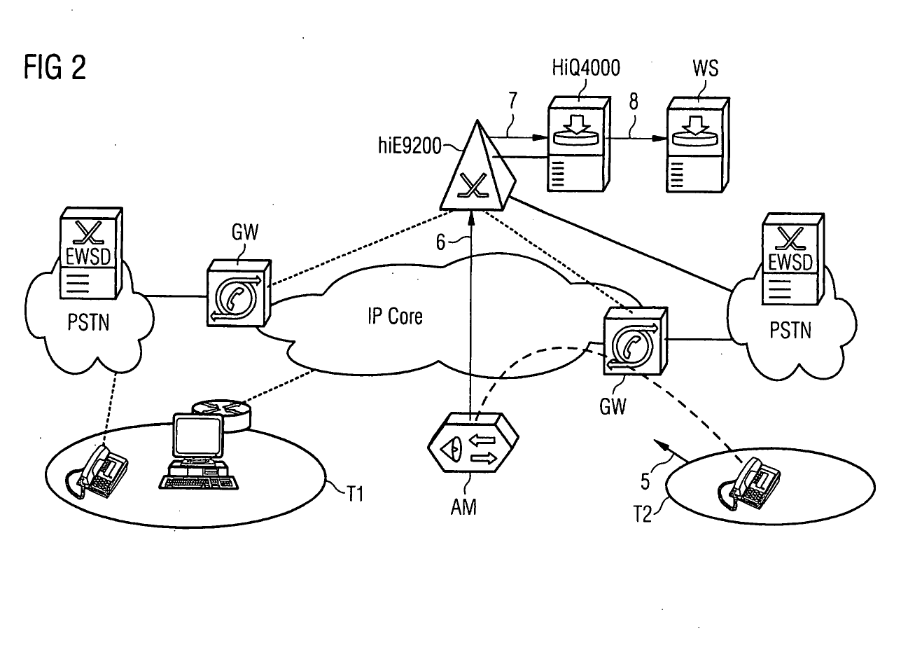

FIG. 3—an exemplary schematic of another embodiment of the invention.

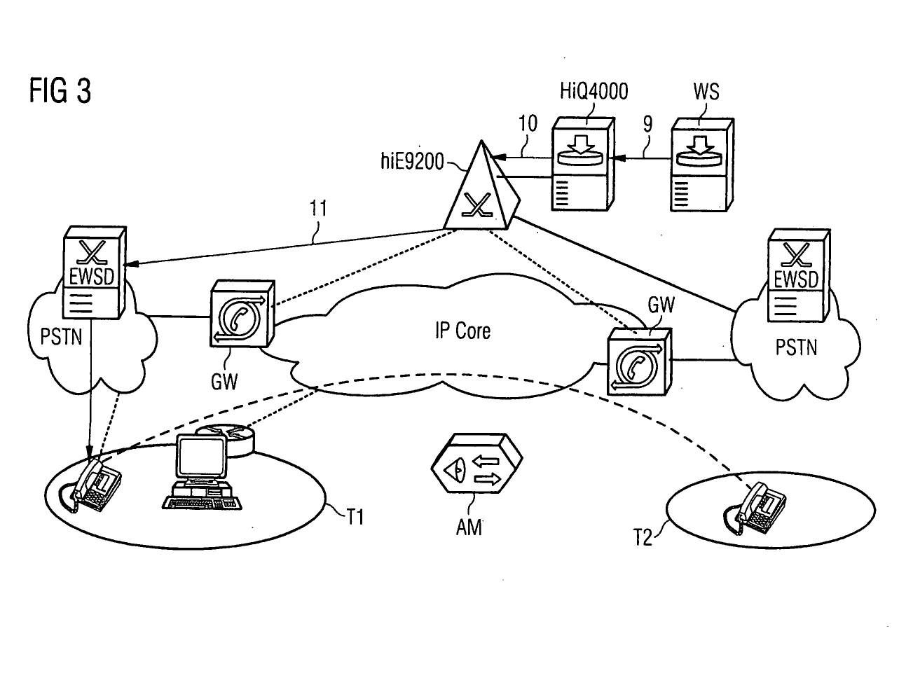

### DETAILED DESCRIPTION OF INVENTION

The exemplary communication network comprises a packet-switched core network in accordance with the Internet protocol IP Core, which is connected, by way of gateways GW, with TDM telephone networks PSTN which include local switching equipment EWSD.

In addition, a central switching equipment such as the SURPASS hiE 9200 model from Siemens AG for example is provided which incorporates both the functionality of a conventional TDM switching center and also a soft switch, in other words a communication component for Next Generation Network (NGN) which makes available services and transmission technology both for conventional telephone networks, networks in accordance with the Internet protocol and mobile radio networks separately from one another. Functions such as routes, protocol conversions, resources or bandwidth management, and the control of media gateways can thus be made available.

An Open Service Platform for IN services, such as the hiQ 4000 model from Siemens for example, is connected as an Application Programming Interface, for example in accordance with the protocol proposed by the Parley Group, to this central hiE 9200 switching center by way of an interface according to the INAP standard for IN services.

In addition, a conventional web server WS is provided as the hardware basis for an application program which is used for managing, updating and evaluating databases containing customer information, and based on which calls are initiated. The call is made with the aid of an announcement machine AM.

The embodiment now relates to a service-based company such as a doctors' practice, for example, in which a permanent connection exists to the patients which represents a first user T1 on the communication network. The patients, further users T2 on the communication network, should attend the practice at regular intervals. The regularly updated customer file containing the information about the respective most recent visit and the appropriate time intervals between visits is stored on the web server WS on which is also running the application program which is used to determine the appropriate period of time for the next visit of each patient. With regard to the example, this database is managed and made available by the doctors' practice.

In the case of a company where the link with the customers is maintained primarily by means of telephone contact, such as in the case of a pizza delivery service for example, this database includes the most recent calls made in each case, from which the ordering habits of the customer in question can be ascertained by the application program. It is thus possible for example to determine that the customer regularly orders a pizza on Friday evenings between 19.00 and 20.00.

This database can be created by detecting calls to the pizza delivery service in the central hiE 9200 switching center by means of an IN trigger point. Each call to this user is then sent to the HiQ 4000 Open Service Platform. The statistical data can then be collected by means of this platform or the web server WS.

Instead of using the web server Ws, provision can also be made whereby the HiQ 4000 Open Service Platform sends its data to a PC located directly in the service-based company, with the result that the data can be utilized locally.

With regard to the present embodiment, on the basis of the evaluated information relating to a particular customer a call will now be initiated to this customer on a Friday evening at 19.00 in order to motivate him to purchase a pizza.

The initiative for this is taken in a first step 1 by the application program on the web server WS by means of an appropriate message to the HiQ 4000 Open Service Platform. This uses the IN function “Collect&Prompt” standardized in accordance with INAP CS.2 in order to establish calls by way of the central hiE 9200 switching center to the announcement machine and to the target customer registered as a further user T2, and then to connect the two (steps 2, 3 and 4).

If the customer T2 wishes to connect to the service provider as a result of the announcement, he should indicate this by means of an appropriate keyed input (step 5). This keyed input—the digit 1 for example—is detected in the announcement machine and signaled in step 6 to the central hiE 9200 switching center. The corresponding communication is based on the Media Gateway Control Protocol (MGPC).

The request is forwarded from the central hiE 9200 switching center by way of the INAP interface to the HiQ 4000 Open Service Platform (step 8) and to the application program on the web server WS. By means of the latter, in the manner already described, the establishment of the connection between the user connections for customer T2 and service provider T1 and the cleardown of the connection with the announcement machine AM are then initiated by way of the HiQ 4000 Open Service Platform and central hiE 9200 switching center.

1-6. (canceled)

7. A method for automatically initiating a call to a first subscriber in a communication network, comprising:
evaluating statistical regularities of calls from the first subscriber to a second subscriber; and
automatically initiating the call to the first subscriber based on the statistical regularities.

8. The method according to claim 7, wherein the automatically initiated call includes an announcement.

9. The method according to claim 8, wherein the announcement is automatically generate based on the statistical regularities.

10. The method according to claim 9,
wherein a connection is established between the first and second subscriber based on an input by the first subscriber, and
wherein the input is specified by the announcement.

11. The method according to claim 8, wherein the statistical regularities include the time of the calls from the first subscriber to the second subscriber.

12. The method according to claim 8, wherein the statistical regularities are the time of the calls from the first subscriber to the second subscriber.

13. The method according to claim 8, wherein the calls from the first subscriber to the second subscriber are evaluated in a switching center connected to the network.

14. The method according to claim 8, wherein the automatically initiated call is initiated in a switching center connected to the network.

15. The method according to claim 8, wherein the calls from the first subscriber to the second subscriber are evaluated in a computer connected to the network.

16. The method according to claim 8, wherein the automatically initiated call is initiated computer connected to the network.

17. The method according to claim 8, wherein the automatically initiated call is initiated on behalf of the second subscriber.
